(19) United States
(12) Patent Application Publication
(10) Pub. No.: US 2007/0121036 A1
(43) Pub. Date: May 31, 2007

(54) Portable display device

(76) Inventors: Chan Kyoung Moon, Ulsan (KR); Tae Soo Kim, Ulsan (KR); Tae Yong Kim, Ulsan (KR); Jung Hoon Kim, Ulsan (KR); Jai Sang Jung, Ulsan (KR)

Correspondence Address: CHRISTIE, PARKER & HALE, LLP, PO BOX 7068, PASADENA, CA, 91109-7068, US

(21) Appl. No.: 11/545,996

(22) Filed: Oct. 10, 2006

(30) Foreign Application Priority Data
Nov. 30, 2005 (KR) 10-2005-0115995

(51) Int. Cl. G02F 1/1335; G02F 1/1333

(52) U.S. Cl. 349/113; 349/58

(57) ABSTRACT

A portable display device includes a liquid crystal layer, a back light assembly comprising a light source for supplying light to the liquid crystal layer, a reflecting plate included in the back light assembly to supply light from the light source to the liquid crystal layer, and at least one adhesive member attached to at least three edges of a rear surface of the reflecting plate. The at least one adhesive member may also be attached to the reflecting plate and a bottom chassis of the back light assembly, a printed circuit board, or a display panel so as to form an air hole.

### CROSS-REFERENCE TO RELATED APPLICATION

This application claims priority to and the benefit of Korean Patent Application No. 10-2005-115995, filed on Nov. 30, 2005, in the Korean Intellectual Property Office, the entire content of which is incorporated herein by reference.

### BACKGROUND

Recently, various flat panel displays (FPDs) have been developed. The FPDs include liquid crystal displays (LCDs), field emission displays (FEDs), plasma display panels (PDPs), and light emitting displays (LEDs).

Among the FPDs, LCDs are small and light and have low power consumption. Currently, LCDs are used in monitors and TVs that are large products as well as in portable devices, such as mobile telephones and personal digital assistants (PDAs).

FIG. 1 is an exploded perspective view illustrating a conventional portable display device. In FIG. 1, a dual display device that is used for a mobile telephone, in which at least one LCD is mounted, is illustrated. FIG. 2 is a perspective view illustrating the rear surface of the reflecting plate illustrated in FIG. 1.

Referring to FIGS. 1 and 2, the conventional portable display device 60 includes a liquid crystal display panel 4, a back light assembly 50, a bottom chassis 22, first and second printed circuit boards 24 and 26, and a light emitting display panel 30.

The liquid crystal display panel 4 displays a predetermined image. The liquid crystal display panel 4 includes a first substrate 4a, a second substrate 4b, and liquid crystal (not shown) implanted between the first and second substrates 4a and 4b.

The second substrate 4b includes a plurality of thin film transistors (TFTs) arranged in a matrix. Here, the source electrodes of the TFTs are connected to data lines and the gate electrodes of the TFTs are connected to scan lines. The drain electrodes of the TFTs are connected to pixel electrodes made of conductive and transparent indium tin oxide (ITO). The TFTs are turned on when scan signals are supplied to the scan lines to supply data signals supplied from the data lines to the pixel electrodes.

An integrated circuit 6 from which the data signals and the scan signals are supplied is inserted into one side of the second substrate 4b. A protective layer 8 is formed around the integrated circuit 6.

The first substrate 4a is arranged to face the second substrate 4b. Common electrodes made of ITO are formed on the front surface of the first substrate 4a. A predetermined voltage is applied to the common electrodes so that a predetermined electric field is formed between the common electrodes and the pixel electrodes. The arrangement angle of the liquid crystal implanted between the first substrate 4a and the second substrate 4b is changed by the electric field and light transmittance is changed by the changed arrangement angle so that it is possible to display a desired image.

Upper and lower polarizers (not shown) are further included on and under the liquid crystal display panel 4.

The back light assembly 50 includes a mold frame 16, light emitting diodes 12, a light emitting diode substrate 14, a light guide plate 18, a reflecting plate 20, and optical sheets 10.

The light emitting diodes 12 generate light of a predetermined brightness in response to driving signals from the light emitting diode substrate 14.

The light guide plate 18 supplies the light supplied from the light emitting diodes 12 to the liquid crystal display panel 4. That is, the light guide plate 18 supplies the light supplied from the sides thereof to the liquid crystal display panel 4 positioned thereon.

The reflecting plate 20 is positioned on the rear surface of the light guide plate 18 to re-supply the light incident from the light guide plate 18 back toward the light guide plate 18. That is, the reflecting plate 20 re-supplies the light incident thereon to the light guide plate 18 to improve optical efficiency. In the context of this disclosure, the “rear” surface refers to the surface on an opposite side as the liquid crystal display panel 4. The reflecting plate 20 is attached to the bottom chassis 22 by adhesive members 21, such as double-sided tapes. The adhesive members 21 are attached to opposite edges on the rear surface of the reflecting plate 20, as illustrated in FIG. 2.

The optical sheets 10 improve the brightness of the light supplied from the light guide plate 18 to supply the light to the liquid crystal display panel 4.

The light emitting diode substrate 14 is connected to the first printed circuit board 24 to supply the driving signals to the light emitting diodes 12 in response to control signals supplied from the first printed circuit board 24.

The light emitting diode substrate 14 in which the light emitting diodes 12 are mounted is accommodated in and fixed to the mold frame 16 and the liquid crystal display panel 4 and the back light assembly 50 are fixedly supported by the mold frame 16.

The bottom chassis 22 is fixed to the mold frame 16 in the lower part of the mold frame 16. An aperture is formed in a part of the bottom chassis 22 so that the light emitting display panel 30 can be inserted into the bottom chassis 22.

The second printed circuit board 26 receives the driving signals from a driving circuit of a mobile telephone (not shown). The second printed circuit board 26 includes a mobile telephone connector 28. The mobile telephone connector 28 is fixed to another connector attached to the driving circuit of the mobile telephone to receive the driving signals from the driving circuit of the mobile telephone. The second printed circuit board 26 that receives the driving signals generates various control signals corresponding to the driving signals supplied thereto.

The first printed circuit board 24 is connected to the second printed circuit board 26 through a first pad unit 38 formed in the second printed circuit board 26. The first printed circuit board 24 is connected to the integrated circuit 6 of the liquid crystal display panel 4 and the light emitting diode substrate 14 by a flexible printed circuit board (not shown). The first printed circuit board 24 connected to the integrated circuit 6 and the light emitting diode substrate 14 drives the integrated circuit 6 and the light emitting diode substrate 14 in response to the control signals supplied from the second printed circuit board 26.

The light emitting display panel 30 includes a first substrate 30a and a second substrate 30b. Organic light emitting diodes (not shown) are arranged on the second substrate 30a in 3 matrix. The organic light emitting diodes generate light of predetermined brightness in response to the amount of current supplied thereto. The light emitting display panel 30 is connected to the second printed circuit board 26 by the second pad unit 36 of a flexible printed circuit board 32. An integrated circuit 34 is mounted on the flexible printed circuit board 32. The integrated circuit 34 allows the light emitting display panel 30 to display a predetermined image in response to the control signals supplied from the second printed circuit board 26.

However, since the reflecting plate 20 is attached to the bottom chassis 22 only by the adhesive members 21 attached to the two edges of the reflecting plate 20 in the above-described conventional portable display device 60, the adhesive force between the reflecting plate 20 and the bottom chassis 22 is weak. Also, foreign substances such as air, moisture, and minute dust may enter the gap between the reflecting plate 20 and the bottom chassis 22 where the adhesive members 21 are not applied.

### SUMMARY OF THE INVENTION

Accordingly, in some embodiments of the present invention, a portable display device is provided in which the adhesive strength of a reflecting plate is improved so that the reliability of the portable display device is improved.

One embodiment of a portable display device includes a liquid crystal layer; a back light assembly including a light source for supplying light to the liquid crystal layer; a reflecting plate included in the back light assembly to supply light from the light source to the liquid crystal layer; and at least one adhesive member attached to at least three edges of a rear surface of the reflecting plate and arranged such that if the at least one adhesive member were to abut a surface, an air hole would be provided between the rear surface of the reflecting plate, the at least one adhesive member, and said surface.

A bottom chassis may also be provided on the rear surface of the reflecting plate for accommodating and supporting the back light assembly, wherein the bottom chassis is attached to the reflecting plate by the at least one adhesive member. The at least one adhesive member may be attached to the at least three edges in the form of an opened square, and may include double-sided tape. The air hole may have a width between 1 mm and 2 mm. Alternatively, a printed circuit board may be positioned on the rear surface of the reflecting plate and attached by the at least one adhesive member.

In another embodiment, the liquid crystal layer is a first display panel, and the portable display device further includes a second display panel positioned on the rear surface of the reflecting plate. The second display panel may be attached to the reflecting plate by the at least one adhesive member, and may be a light emitting display panel including a first substrate, light emitting diodes arranged on the first substrate, and a second substrate facing the first substrate. In one embodiment, the second display panel is a liquid crystal display panel.

Another embodiment of a portable display device includes a liquid crystal layer; a back light assembly including a light source for supplying light to the liquid crystal layer; a reflecting plate included in the back light assembly to supply light from the light source to the liquid crystal layer; and at least one adhesive member attached to at least three edges of a rear surface of the reflecting plate. The at least one adhesive member may surround a central portion of the rear surface of the reflecting plate and define at least one opening to the central portion. The at least one opening may be between 1 mm and 2 mm.

One embodiment also includes a bottom chassis provided on the rear surface of the reflecting plate for accommodating and supporting the back light assembly, wherein the bottom chassis is attached to the reflecting plate by the at least one adhesive member such that an air hole is formed between the bottom chassis, the at least one adhesive member, and the rear surface of the reflecting plate.

Alternatively, a printed circuit board may be positioned on the rear surface of the reflecting plate, such as attached to the reflecting plate by the at least one adhesive member such that an air hole is formed between the printed circuit board, the at least one adhesive member, and the rear surface of the reflecting plate.

In one embodiment, the liquid crystal layer is a first display panel, and the portable display device further includes a second display panel positioned on the rear surface of the reflecting plate. The second display panel may be attached to the reflecting plate by the at least one adhesive member such that an air hole is formed between the second display panel, the at least one adhesive member, and the rear surface of the reflecting plate. The second display panel may be a light emitting display panel including a first substrate, light emitting diodes arranged on the first substrate, and a second substrate facing the first substrate.

### BRIEF DESCRIPTION OF THE DRAWINGS

These and/or other features and aspects of the invention will become apparent and more readily appreciated from the following description of examples of embodiments, taken in conjunction with the accompanying drawings of which:

FIG. 1 is an exploded perspective view illustrating a conventional portable display device;

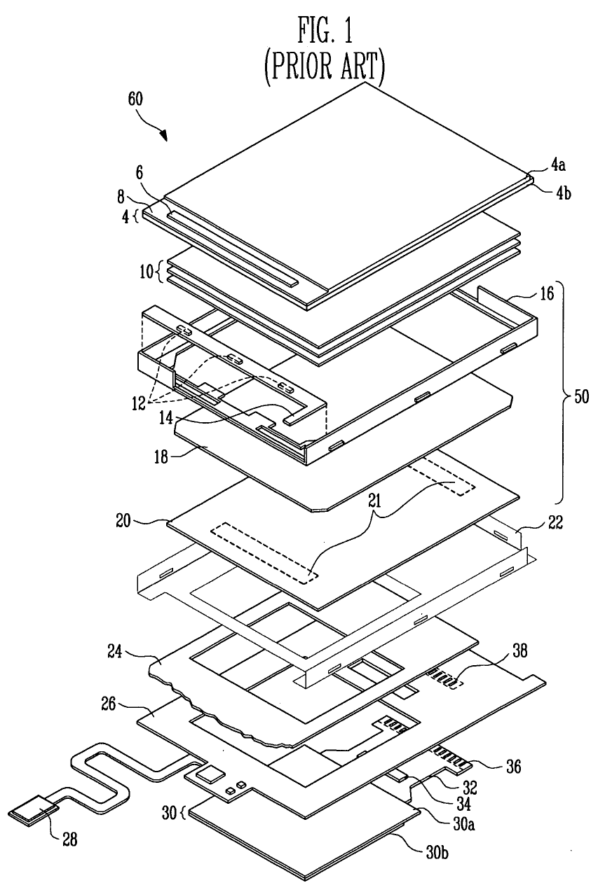

FIG. 2 is a perspective view illustrating the rear surface of the reflecting plate illustrated in FIG. 1;

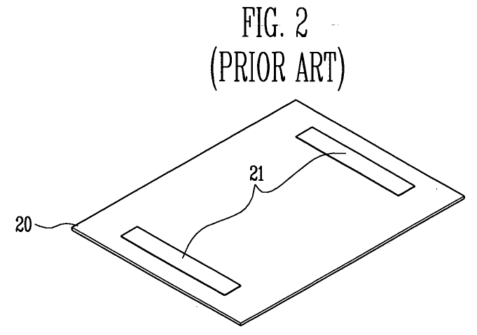

FIG. 3 is an exploded perspective view illustrating a portable display device according to an embodiment of the present invention; and

FIG. 4 is a perspective view illustrating the rear surface of the reflecting plate illustrated in FIG. 3.

### DETAILED DESCRIPTION

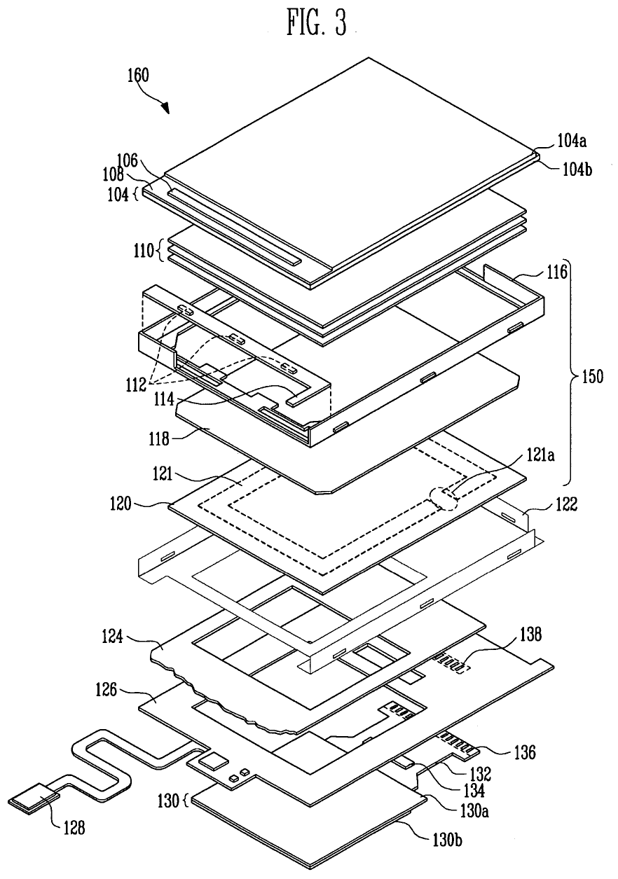

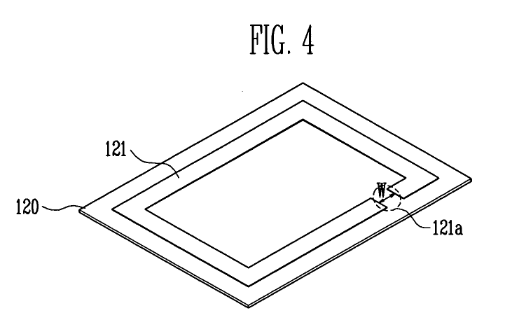

Hereinafter, examples of embodiments according to the present invention will be described with reference to FIGS. 3 and 4.

FIG. 3 is an exploded perspective view illustrating a portable display device according to an embodiment of the present invention. In FIG. 3, a dual display device that is used for a mobile telephone, in which at least one liquid crystal display (LCD) is mounted, is illustrated. The present invention, however, is not limited to the above. FIG. 4 is a perspective view illustrating the rear surface of the reflecting plate illustrated in FIG. 3.

Referring to FIGS. 3 and 4, the portable display device 160 according to this embodiment of the present invention includes a liquid crystal display panel 104, a back light assembly 150, a bottom chassis 122, first and second printed circuit boards 124 and 126, and a light emitting display panel 130.

The liquid crystal display panel 104 displays a predetermined image. The liquid crystal display panel 104 includes a first substrate 104a, a second substrate 104b, and liquid crystal (not shown) implanted between the first substrate 104a and the second substrate 104b.

The second substrate 104b includes a plurality of transistors (TFTs) arranged in a matrix. Here, the source electrodes of the TFTs are connected to data lines, and the gate electrodes of the TFTs are connected to scan lines. The drain electrodes of the TFTs are connected to pixel electrodes made of conductive and transparent indium tin oxide (ITO). The TFTs are turned on when scan signals are supplied to the scan lines to supply data signals, supplied from the data lines, to the pixel electrodes.

An integrated circuit 106 from which the data signals and the scan signals are supplied is inserted into one side of the second substrate 104b. A protective layer 8 is formed around the integrated circuit 106.

The first substrate 104a is arranged to face the second substrate 104b. Common electrodes made of ITO are formed on the front surface of the first substrate 104a. A predetermined voltage is applied to the common electrodes so that a predetermined electric field is formed between the common electrodes and the pixel electrodes. The arrangement angle of the liquid crystal implanted between the first substrate 104a and the second substrate 104b is changed by the electric field and light transmittance is changed by the changed arrangement angle so that it is possible to display a desired image.

Upper and lower polarizers (not shown) may also be included on and under the liquid crystal display panel 104.

The back light assembly 150 includes a mold frame 116, light emitting diodes 112, a light emitting diode substrate 114, a light guide plate 118, a reflecting plate 120, and optical sheets 110.

The light emitting diodes 112 act as a light source for supplying light to the liquid crystal layer of the liquid crystal display panel 104, and generate light of a predetermined brightness in response to driving signals from the light emitting diode substrate 114.

The light guide plate 118 supplies the light supplied from the light emitting diodes 112 to the liquid crystal display panel 104. That is, the light guide plate 118 supplies the light supplied from the sides thereof to the liquid crystal display panel 104 positioned thereon.

The reflecting plate 120 is positioned on the rear surface of the light guide plate 118 to re-supply the light incident from the light guide plate 118 back toward the light guide plate 118. That is, the reflecting plate 120 supplies the light incident. thereon to the liquid crystal layer of the liquid crystal display panel 104 via the light guide plate 118 to improve optical efficiency. The reflecting plate 120 is attached to the rear surface of the bottom chassis 122 positioned by adhesive members 121, such as double-sided tapes. The adhesive members 121 are attached to at least three edges of the rear surface of the reflecting plate 120 so that the adhesive strength of the reflecting plate 120 is improved and that inflow of foreign substances is reduced. For example, the adhesive members 121 may be attached to the four edges of the rear surface of the reflecting plate 120 in the form of a square, as illustrated in FIG. 4. Although multiple adhesive members 121 are shown in FIGS. 3 and 4, a single adhesive member may also be used.

If the adhesive members 121 are attached to the four edges of the reflecting plate 120 in the form of a closed square, foreign substances such as air and moisture may flow to the between the adhesive members 121. Thus, when thermal shock is applied from the outside, the foreign substances expand to swell so that the adhesive strength between the reflecting plate 120 and the bottom chassis 122 deteriorates, and the reliability of the portable display device 160 deteriorates as a result.

In the embodiment of the present invention shown in FIGS. 3 and 4, the adhesive members 121 are attached to the four edges of the rear surface of the reflecting plate 120 to surround a central area of the reflecting plate 120 and to define an opening to the central area. Thus, when the reflecting plate 120 is attached to the bottom chassis 122 by the adhesive members 121, an air hole 121a having width W of about 1 mm to 2 mm is formed. That is, the adhesive members 121 are attached to the reflecting plate 120 in the form of an opened square having the air hole 121a. In this embodiment, although the foreign substances such as air and moisture flow to the area between the adhesive members 121 when the reflecting plate 120 and the bottom chassis 122 are attached to each other, the foreign substances that expand when thermal shock is applied are discharged through the air hole 121a so that the foreign substances do not swell. Therefore, it is possible to improve the adhesive strength between the reflecting plate 120 and the bottom chassis 122 and to improve the reliability of the portable display device 160 compared with the conventional art.

Further, since double-sided tapes are provided at the four edges of the reflecting plate 120, excluding the part of the air hole 121a, it is possible to reduce the inflow of the foreign substances after the reflecting plate 120 and the bottom chassis 122 are attached to each other.

Although only the case in which the bottom chassis 122 is included has been described above, the present invention is not limited to the above. For example, when the bottom chassis 122 is not included, the reflecting plate 120 may be attached to the first printed circuit board 124 or the first substrate 130a of the light emitting display panel 130. In this case, the adhesive members 121 are attached to the rear surface of the reflecting plate 120 so that the air hole 121a is formed to attach the reflecting plate 120 and the first printed circuit board 124 or the light emitting display panel 130 to each other.

The optical sheets 110 improve the brightness of the light supplied from the light guide plate 118 to supply the light to the liquid crystal display panel 104.

The light emitting diode substrate 114 is connected to the first printed circuit board 124 to supply the driving signals to the light emitting diodes 112 in response to control signals supplied from the first printed circuit board 124.

The light emitting diode substrate 114 in which the light emitting diodes 112 are mounted is accommodated in and fixed to the mold frame 116 and the liquid crystal display panel 104 and the back light assembly 150 are fixedly supported to the mold frame 116.

The bottom chassis 122 is fixed to the mold frame 116 in the lower part of the mold frame 116 to accommodate and support the back light assembly 150. An aperture is formed in a part of the bottom chassis 122 so that the light emitting display panel 130 can be inserted into the bottom chassis 122.

The second printed circuit board 126 receives the driving signals from a driving circuit of a mobile telephone (not shown). The second printed circuit board 126 includes a mobile telephone connector 128. The mobile telephone connector 128 is fixed to another connector attached to the driving circuit of the mobile telephone to receive the driving signals from the driving circuit of the mobile telephone. The second printed circuit board 126 that receives the driving signals generates various control signals corresponding to the driving signals supplied thereto.

The first printed circuit board 124 is connected to the second printed circuit board 126 through a first pad unit 138 formed in the second printed circuit board 126. The first printed circuit board 124 is connected to the integrated circuit 106 of the liquid crystal display panel 104 and the light emitting diode substrate 114 by a flexible printed circuit board (not shown). The first printed circuit board 124 connected to the integrated circuit 106 and the light emitting diode substrate 114 drives the integrated circuit 106 and the light emitting diode substrate 114 in response to the control signals supplied from the second printed circuit board 126.

The light emitting display panel 130 includes a first substrate 130a and a second substrate 130b. Organic light emitting diodes (not shown) are arranged on the first substrate 130a in a matrix. The organic light emitting diodes generate light of predetermined brightness in response to the amount of current supplied thereto. The light emitting display panel 130 is connected to the second printed circuit board 126 by the second pad unit 136 of a flexible printed circuit board 132. An integrated circuit 134 is mounted on the flexible printed circuit board 132. The integrated circuit 134 allows the light emitting display panel 130 to display a predetermined image in response to the control signals supplied from the second printed circuit board 126. The light emitting display panel 130 may also be substituted for a liquid crystal display panel or any other suitable display panel.

As described above, according to the portable display device 160 of this embodiment of the present invention, the adhesive members 121 are attached to at least three edges of the reflecting plate 120 to attach the reflecting plate 120 and the bottom chassis 122 to each other so that it is possible to improve the adhesive strength between the reflecting plate 120 and the bottom chassis 122 and to reduce the amount of the foreign substances flowing between the reflecting plate 120 and the bottom chassis 122. In one embodiment of the invention, the adhesive members 121 are attached to the four edges of the reflecting plate 120 not in the form of a closed square, but having an air hole 121a formed on at least one edge of the square so that it is possible to prevent the foreign substances from swelling when thermal shock is applied from the outside, thereby improving the reliability of the portable display device 160.

As described above, the adhesive members in this embodiment are attached to at least three edges of the rear surface of the reflecting plate to attach the reflecting plate and the bottom chassis to each other so that it is possible to improve the adhesive strength of the reflecting plate and to reduce the inflow of foreign substances. Also, the air hole is formed when the adhesive members are attached so that it is possible to improve the reliability of the portable display device.

Although examples of embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A portable display device comprising:
a liquid crystal layer;
a back light assembly comprising a light source for supplying light to the liquid crystal layer;
a reflecting plate included in the back light assembly and facing the liquid crystal layer to supply light from the light source to the liquid crystal layer; and
at least one adhesive member attached to at least three edges of a rear surface of the reflecting plate and arranged such that if the at least one adhesive member were to abut a surface, an air hole would be provided between the rear surface of the reflecting plate, the at least one adhesive member, and said surface.

2. The portable display device as claimed in claim 1, further comprising a bottom chassis provided on the rear surface of the reflecting plate for accommodating and supporting the back light assembly, wherein the bottom chassis is attached to the reflecting plate by the at least one adhesive member.

3. The portable display device as claimed in claim 1, wherein the at least one adhesive member is attached to the at least three edges in the form of an opened square.

4. The portable display device as claimed in claim 1, wherein the air hole has a width between 1 mm and 2 mm.

5. The portable display device as claimed in claim 1, wherein the at least one adhesive member comprises double-sided tape.

6. The portable display device as claimed in claim 1, further comprising a printed circuit board positioned on the rear surface of the reflecting plate.

7. The portable display device as claimed in claim 6, wherein the printed circuit board is attached to the reflecting plate by the at least one adhesive member.

8. The portable display device as claimed in claim 1, wherein the liquid crystal layer is a first display panel, and wherein the portable display device further comprises a second display panel positioned on the rear surface of the reflecting plate.

9. The portable display device as claimed in claim 8, wherein the second display panel is attached to the reflecting plate by the at least one adhesive member.

10. The portable display device as claimed in claim 8, wherein the second display panel is a light emitting display panel comprising:
a first substrate;
light emitting diodes arranged on the first substrate; and
a second substrate facing the first substrate.

11. The portable display device as claimed in claim 8, wherein the second display panel is a liquid crystal display panel.

12. A portable display device comprising:
a liquid crystal layer;
a back light assembly comprising a light source for supplying light to the liquid crystal layer;
a reflecting plate included in the back light assembly to supply light from the light source to the liquid crystal layer; and
at least one adhesive member attached to at least three edges of a rear surface of the reflecting plate.

13. The portable display device as claimed in claim 12, wherein the at least one adhesive member surrounds a central portion of the rear surface of the reflecting plate and defines at least one opening to the central portion.

14. The portable display device as claimed in claim 13, wherein the at least one opening is between 1 mm and 2 mm.

15. The portable display device as claimed in claim 12, further comprising a bottom chassis provided on the rear surface of the reflecting plate for accommodating and supporting the back light assembly, wherein the bottom chassis is attached to the reflecting plate by the at least one adhesive member such that an air hole is formed between the bottom chassis, the at least one adhesive member, and the rear surface of the reflecting plate.

16. The portable display device as claimed in claim 12, further comprising a printed circuit board positioned on the rear surface of the reflecting plate.

17. The portable display device as claimed in claim 16, wherein the printed circuit board is attached to the reflecting plate by the at least one adhesive member such that an air hole is formed between the printed circuit board, the at least one adhesive member, and the rear surface of the reflecting plate.

18. The portable display device as claimed in claim 12, wherein the liquid crystal layer is a first display panel, and wherein the portable display device further comprises a second display panel positioned on the rear surface of the reflecting plate.

19. The portable display device as claimed in claim 18, wherein the second display panel is attached to the reflecting plate by the at least one adhesive member such that an air hole is formed between the second display panel, the at least one adhesive member, and the rear surface of the reflecting plate.

20. The portable display device as claimed in claim 18, wherein the second display panel is a light emitting display panel comprising:
a first substrate;
light emitting diodes arranged on the first substrate; and
a second substrate facing the first substrate.
